(19) United States
(12) Patent Application Publication
(10) Pub. No.: US 2015/0241997 A1
(43) Pub. Date: Aug. 27, 2015

(54) COORDINATE DETECTION SYSTEM, INFORMATION PROCESSING APPARATUS, METHOD OF DETECTING COORDINATE, AND PROGRAM

(71) Applicant: Yasuhiro ONO, Kanagawa (JP)

(72) Inventor: Yasuhiro ONO, Kanagawa (JP)

(73) Assignee: RICOH COMPANY, LTD., Tokyo (JP)

(21) Appl. No.: 14/623,910

(22) Filed: Feb. 17, 2015

(30) Foreign Application Priority Data
Feb. 25, 2014 (JP) 2014-033680

(51) Int. Cl. G06F 3/0354

(52) U.S. Cl. CPC G06F 3/0354

(57) ABSTRACT

A coordinate detection system for detecting a coordinate pointed by a pointer with which a pointing operation is performed on a board face includes a first calculation unit that extracts a plurality of areas respectively indicative of a plurality of annular members provided in the pointer from a picked-up image picked by an image pick-up unit arranged at a predetermined position of the board face and calculates center positions of the extracted areas; and a second calculation unit that calculates a position of a tip portion of the pointer on the board face based on the center positions of the areas calculated by the first calculation unit and a position of a principal point of the image pick-up unit.

### BACKGROUND OF THE INVENTION

1. Field of the Invention

The present invention relates to a coordinate detection system, an information processing apparatus, a method of detecting coordinate, and a program.

2. Description of the Related Art

An exemplary coordinate detection system which detects a coordinate pointed by a pointer such as an electronic pen and displays a handwritten character or the like is a coordinate detection system of an optical type (for example, Patent Documents 1 and 2).

Patent Document 1: Japanese Laid-Open Patent Publication No. 2005-173684

Patent Document 2: Japanese Patent No. 5122948

### SUMMARY OF THE INVENTION

It is a general object of at least one embodiment of the present invention to provide a coordinate detection system that substantially obviates one or more problems caused by the limitations and disadvantages of the related art.

One aspect of the embodiments of the present invention may be to provide a coordinate detection system for detecting a coordinate pointed by a pointer with which a pointing operation is performed on a board face including a first calculation unit that extracts a plurality of areas respectively indicative of a plurality of annular members provided in the pointer from a picked-up image picked by an image pick-up unit arranged at a predetermined position of the board face and calculates center positions of the extracted areas; and a second calculation unit that calculates a position of a tip portion of the pointer on the board face based on the center positions of the areas calculated by the first calculation unit and a position of a principal point of the image pick-up unit.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

### BRIEF DESCRIPTION OF THE DRAWINGS

FIG. 1 illustrates an exemplary system structure of a coordinate detection system of an embodiment.

FIG. 2 illustrates an exemplary hardware structure of the coordinate detection system.

FIG. 3 illustrates an exemplary structure of a pointer.

FIG. 4 illustrates a procedure of calculating a coordinate of a vertex of a pointer.

FIG. 5A illustrates an arrangement of a CMOS image sensor.

FIG. 5B illustrates another arrangement of the CMOS image sensor.

FIG. 5C illustrates another arrangement of the CMOS image sensor.

FIG. 6 illustrates a method of calculating the coordinate of the vertex of a pointer based on intersecting lines.

FIG. 7 illustrates the internal structure of an image pick-up unit.

FIG. 8 illustrates the coordinate of an element on a CMOS image sensor corresponding to a center point in a case where there is no lens distortion.

FIG. 9 illustrates the coordinate of the element on the CMOS image sensor corresponding to the center point in a case where there is a lens distortion.

FIG. 10 explains a method of calculating the coordinate of the element on the CMOS image sensor corresponding to the center point.

FIG. 11 illustrates an exemplary functional structure of a coordinate detection program.

FIG. 12 illustrates a light emission area drawn on a picked-up image.

FIG. 13A illustrates a pixel on a picked-up image corresponding to a center point. FIG. 13B illustrates the pixel on the picked-up image corresponding to the center point.

FIG. 14 illustrates another exemplary functional structure of the coordinate detection program.

### DETAILED DESCRIPTION OF THE PREFERRED EMBODIMENTS

In a case of the coordinate detection system of the optical type, a light from the pointer is picked up by multiple image pick-up units arranged at different positions and the coordinate of the tip portion of the pointer is calculated by using a triangulation method.

Therefore, it is desirable that a material of a light emission portion (a reflective portion) of the pointer is formed in an annular shape in a peripheral direction of the pointer so that the light from the pointer can be securely picked up by the multiple image pick-up units.

However, in a case where the light emission portion of the pointer (or the reflective portion) is formed in the annular shape in its peripheral direction, a light from the pointer is drawn as a light emission area having a predetermined area on a picked-up image picked up by the image pick-up unit.

In order to accurately calculate the coordinate of the tip portion of the pointer, it is necessary to accurately extract a pixel corresponding to the center axis of the pointer from the light area. However, the center position of the light area does not conform with the center axis of the pointer. Therefore, an occurrence of an error is unavoidable in a case where the coordinate of the tip portion of the pointer is calculated based on the center position of the light area.

The present invention is provided to accurately calculate the coordinate of the tip portion of the pointer in consideration of the above problems.

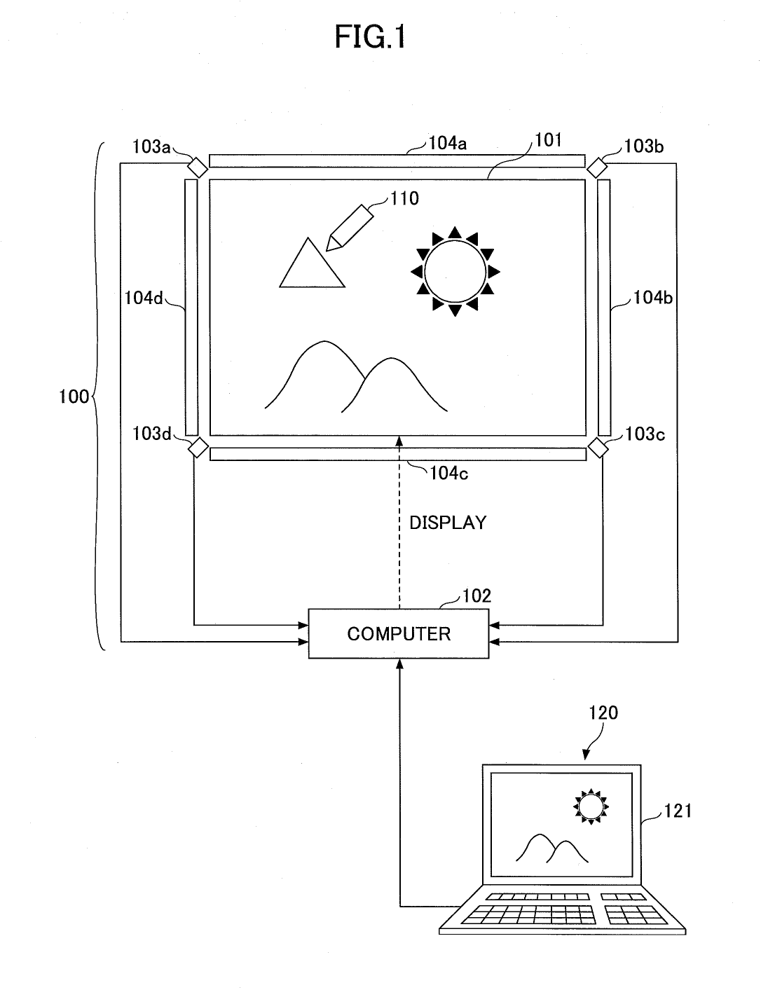

A description is given below, with reference to the FIG. 1 through FIG. 14 of embodiments of the present invention. Where the same reference symbols are attached to the same parts, repeated description of the parts is omitted.

Reference symbols typically designate as follows:

100: coordinate detection system;

101: coordinate input apparatus;

102: computer (information processing apparatus);

103a-103d: image pick-up unit;

104a-104d: peripheral light emission unit;

110: pointer;

120: terminal apparatus;

310: grip portion;

311: light emission circuit;

320: tip portion;

321, 322: light emission portion;

323: vertex;

331, 332: center point;

501a: CMOS image sensor;

530: plane;

540a, 540b: intersecting line;

701a: lens;

1200: picked-up image; and

1210, 1220: light emission area.

### First Embodiment

### <1. System Structure of Coordinate Detection System>

Firstly, described is a system structure of a coordinate detection system of an embodiment. FIG. 1 illustrates an exemplary system structure of a coordinate detection system of the embodiment.

Referring to FIG. 1, the coordinate detection system 100 includes a coordinate input apparatus 101, a computer (an information processing apparatus) 102, image pick-up units 103a to 103d, peripheral light emission units 104a to 104d, and a pointer 110. A terminal apparatus 120 is connected to the computer (the information processing apparatus) 102 of the coordinate detection system 100.

The coordinate input apparatus 101 displays an image generated by the terminal apparatus 120 and displays a content handwritten by a pointing operation on an input face, which is a board face of the coordinate input apparatus 101, using the pointer.

The computer (the information processing apparatus) 102 controls the coordinate input apparatus 101 so that an image sent by the terminal apparatus 120 is displayed on the coordinate input apparatus 101. Referring to FIG. 1, an image displayed on the display unit 121 of the terminal apparatus.

Further, the computer 102 analyzes pointing (a contact position between the input face and the tip portion of the pointer 110) input into the input face of the coordinate input apparatus 101 based on a picked-up image picked up by the image pick-up units 103a to 103d in real time. Further, a line is formed by connecting time-series coordinates and controls so that the handwritten content is displayed on the coordinate input apparatus 101.

Referring to FIG. 1, a user performs a pointing operation by moving the pointer 110 along a shape of a triangle on the input face. Thus, the computer 102 superimposes sequential coordinates as one stroke (the triangle) on the displayed image.

As such, even though the coordinate input apparatus 101 does not have a touch panel function, the user can perform various inputs by causing the tip portion of the pointer 110 to touch the coordinate input apparatus 101.

The image pick-up units 103a to 103d are provided to shoot the entire input face of the coordinate input apparatus 101 and arranged at a predetermined position (both end positions in the embodiment) on the input face of the coordinate input apparatus 101. Within the embodiment the image pick-up units 103a and 103b shoot an upper half of the input face of the coordinate input apparatus 101 and the image pick-up units 103c and 103d shoot a lower half of the input face of the coordinate input apparatus 101. The coordinate of the contact position of the tip portion if the pointer 110 is calculated based on a picked-up image obtained by shooting the pointer using the image pick-up unit.

The peripheral light emission units 104a to 104d are arranged in the periphery of the coordinate input apparatus 101 and irradiates the input face of the coordinate input apparatus 101. The peripheral light emission units 104a to 104d may be detachably attached to the coordinate input apparatus 101.

### <2. Hardware Structure of Coordinate Detection System>

Next, a hardware structure of the coordinate detection system 100 is described.

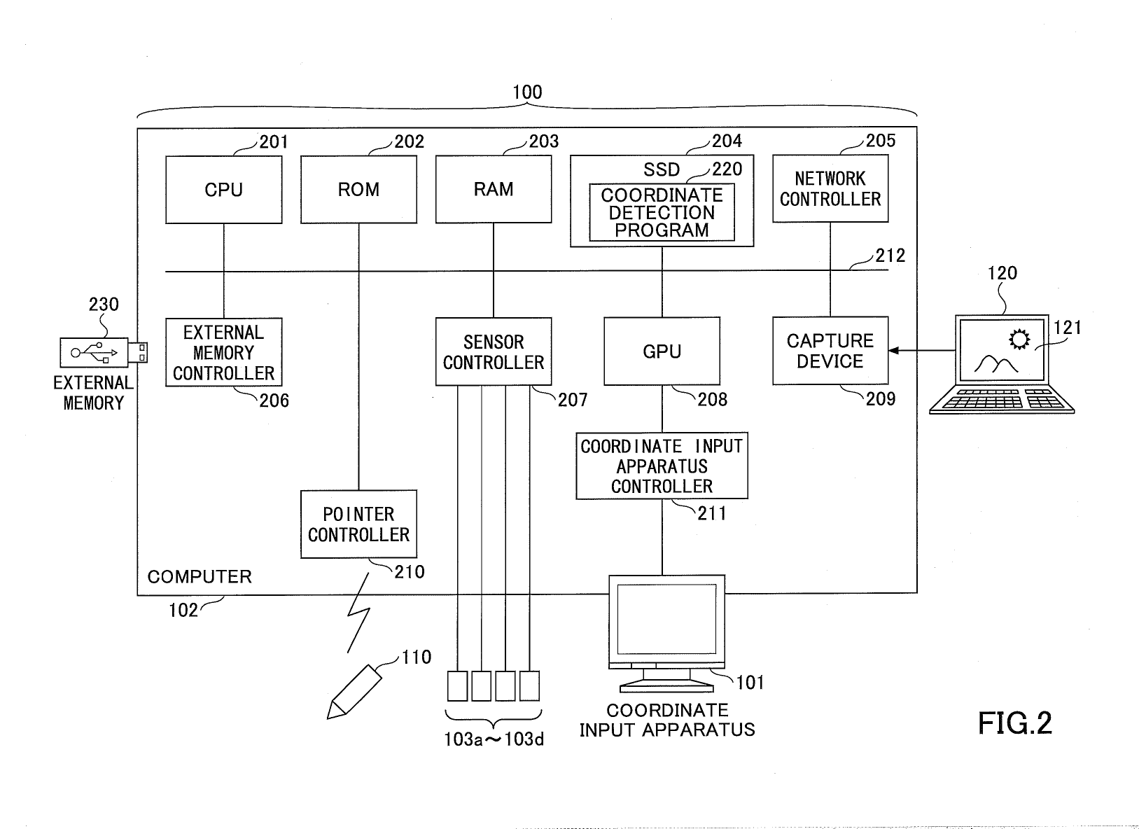

FIG. 2 illustrates an exemplary hardware structure of the coordinate detection system 100.

Referring to FIG. 2, the computer 102 is an information processing apparatus developed for a commercially available information processing apparatus or a coordinate detection system. The computer 102 includes a CPU 201, a ROM 202, a RAM 203, a solid state drive (SSD) 204, and a network controller 205 electrically connected a bus line 212 such as an address bus or a data bus. The computer 102 further includes an external memory controller 206, a sensor controller 207, a graphics processing unit (GPU) 208, and a capture device 209.

The CPU 202 runs the coordinate detection program 220 and simultaneously controls entire operations of the coordinate detection system 100. The ROM 202 stores an initial program loader (IPL) or the like and mainly stores a program run by the CPU 201 at a time of starting up the computer 201. The RAM 203 functions as a work area used by the CPU 201 at a time of executing, for example, a coordinate detection program 220.

An SSD 204 is a non-volatile memory in which a coordinate detection program 220 and various data are stored. The network controller 205 performs a process based on a communication protocol when the computer 100 communicates with a server through a network (not illustrated). This network includes a local area network (LAN), a wide area network (WAN) formed by connecting multiple LANs such as the Internet, or the like.

The external memory controller 206 reads out data from the detachable external memory 230. The external memory 230 includes a universal serial bus (USB) memory, a SD card, and so on.

The four image pick-up units 103a to 103d are connected to the sensor controller 207 to control shooting with these four image pick-up units 103a to 103d.

A GPU 208 is a processor exclusively used for drawing for Calculating pixel values of pixels of an image displayed on the coordinate input apparatus 101. The coordinate input apparatus controller 211 outputs an image formed by the GPU 208 to the coordinate input apparatus 101.

The capture device 209 takes in (captures) an image displayed on a display unit 121 by the terminal apparatus 120.

In a case of the coordinate detection system 100 of the embodiment, the computer 102 needs not to communicate with the pointer 110 but may have a communication function for communicating with the pointer 110. In this case, the computer 102 includes a pointer controller 210 for communicating with the pointer 110. With this, the computer 102 can receive a control signal from the pointer 10.

The coordinate detection program 200 may be put into circulation while the coordinate detection program 200 is stored in the external memory 230 or may be downloaded from a server (not illustrated) through the network controller 205. At this time, the coordinate detection program 220 may be in a compressed state or in a state of executable format.

### <3. Structure of Pointer>

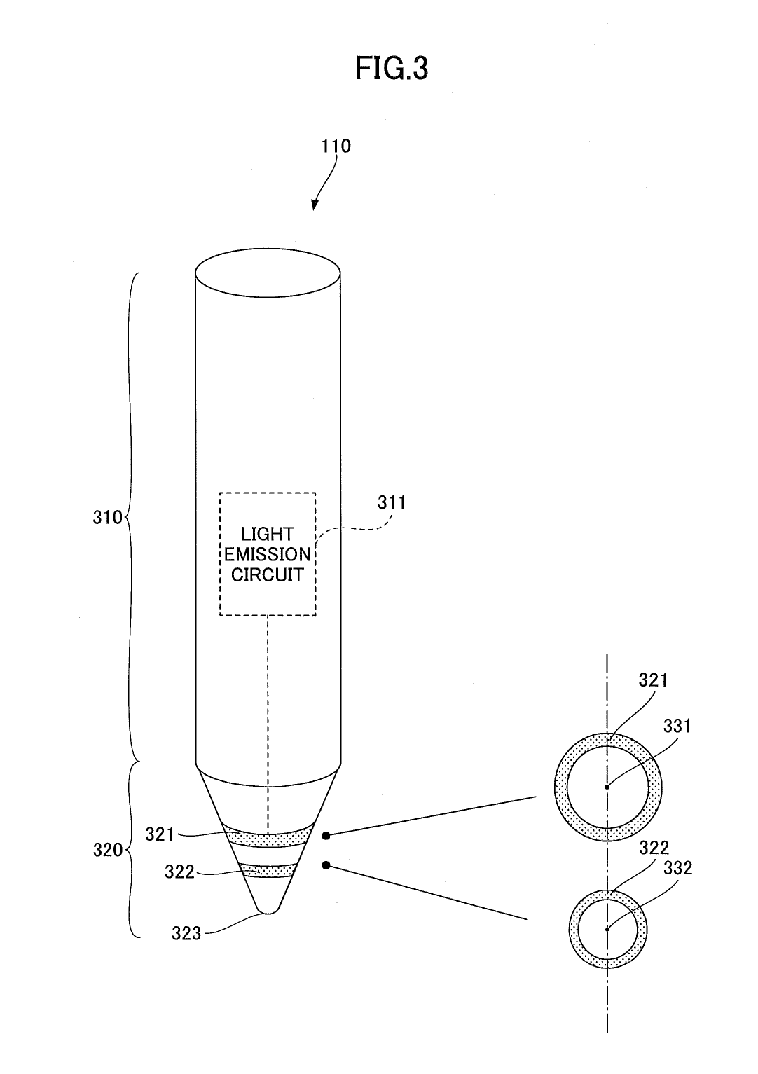

Next, the structure of the pointer 110 is described. FIG. 3 illustrates the structure of the pointer 110. Referring to FIG. 3, the pointer 110 includes a grip portion 310 to be gripped by the user and a tip portion 320 to be contact with the input face of the coordinate input apparatus 101.

The grip portion has a cylindrical shape so as to be easily gripped by the user. A light emission circuit 311 is provided inside the light emission circuit 311. However, the cylindrical shape is an example and another shape may be used. The tip portion 320 has a conic shape and is provided with annular light emission portions 321 and 322 (the conic shape is an example and may be another shape.) The light emission portions 321 and 322 are controlled to be turned ON/OFF by the light emission circuit 311 and emit light having a predetermined light quantity.

Hereinafter, a part of the tip portion 320 directly contacting the input face of the coordinate input apparatus 101 is referred to as a “vertex”. Within the embodiment, the vertex 323 of the tip portion 320 is positioned on a linear line connecting a center point 331 of a circle of a cross-section (see the right side of FIG. 3) of the light emission portion 321 with a center point 332 of a circle of a cross-section (see the right side of FIG. 3) of the light emission portion 322. The linear line passing through the center point 331, the center point 332, and the vertex 323 is referred to as a “center axis” of the pointer 110.

Said differently, the light emission portions 321 and 322 are arranged such that these cross-sections are substantially orthogonal to the center axis and the centers of these cross-sections substantially conform with the center axis.

### <4. Explanation of Procedure of Calculating Vertex Coordinate of Pointer>

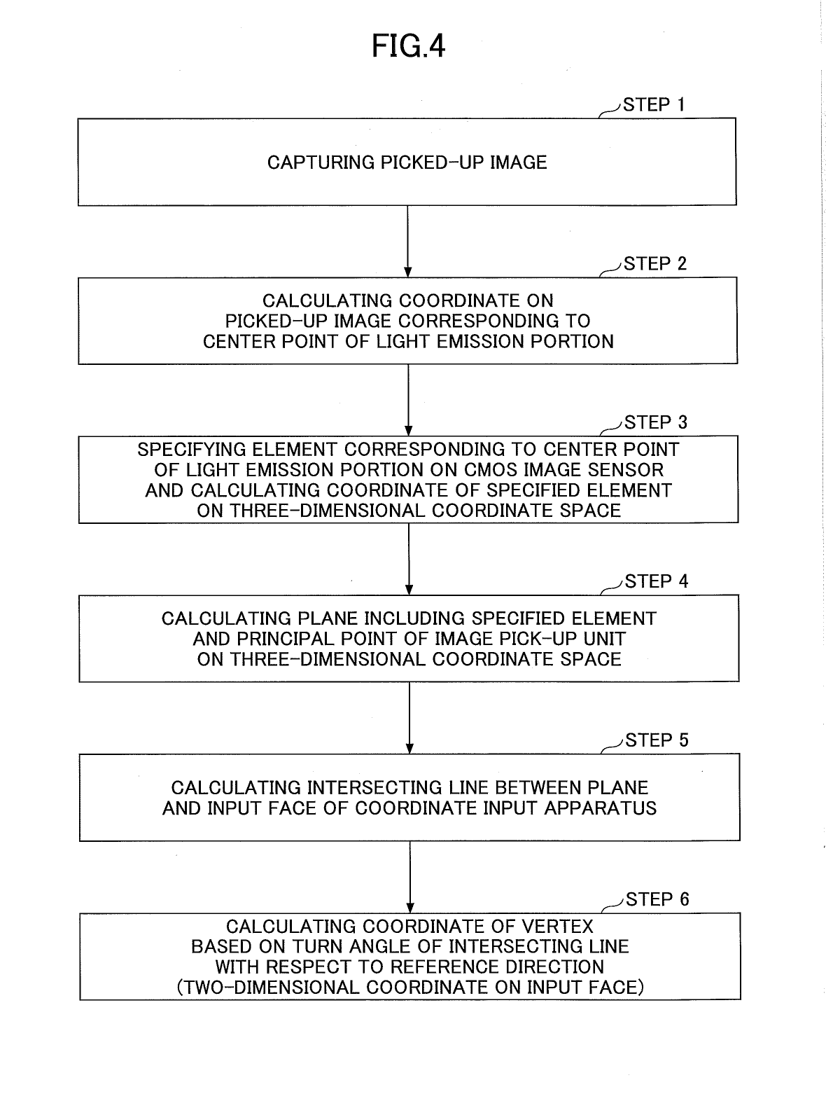

Next described is a procedure of calculating a two-dimensional coordinate (a two-dimensional coordinate of the contact position between the input face and the vertex 323 of the pointer 110) of the vertex 323 of the pointer 110 on the input face of the coordinate input apparatus 101. FIG. 4 illustrates a procedure of calculating the coordinate of the vertex 323 of the pointer 110 on the input face of the coordinate input apparatus 101.

In a case where the pointer 110 (see FIG. 3) provided with the annular light emission portions 321 and 322 at the tip portion 320 in the coordinate detection system of the optical type is used, the two-dimensional coordinate of the vertex 323 on the input face can be calculated by processing the picked-up image in conformity with the procedure illustrated in FIG. 4.

Specifically, a picked-up image is obtained by shooting with the image pick-up units 103a to 103d (step 1).

Subsequently, the two-dimensional coordinates of the center points of the light emission portions 321 and 322 on the picked-up image are calculated based on the obtained picked-up image (step 2).

Subsequently, elements on the CMOS image sensor corresponding to the two-dimensional coordinates of the center points 331 and 332 on the picked-up image are specified (step 3). Further, the three-dimensional coordinates of the specified elements in the three-dimensional coordinate space are calculated (step 3).

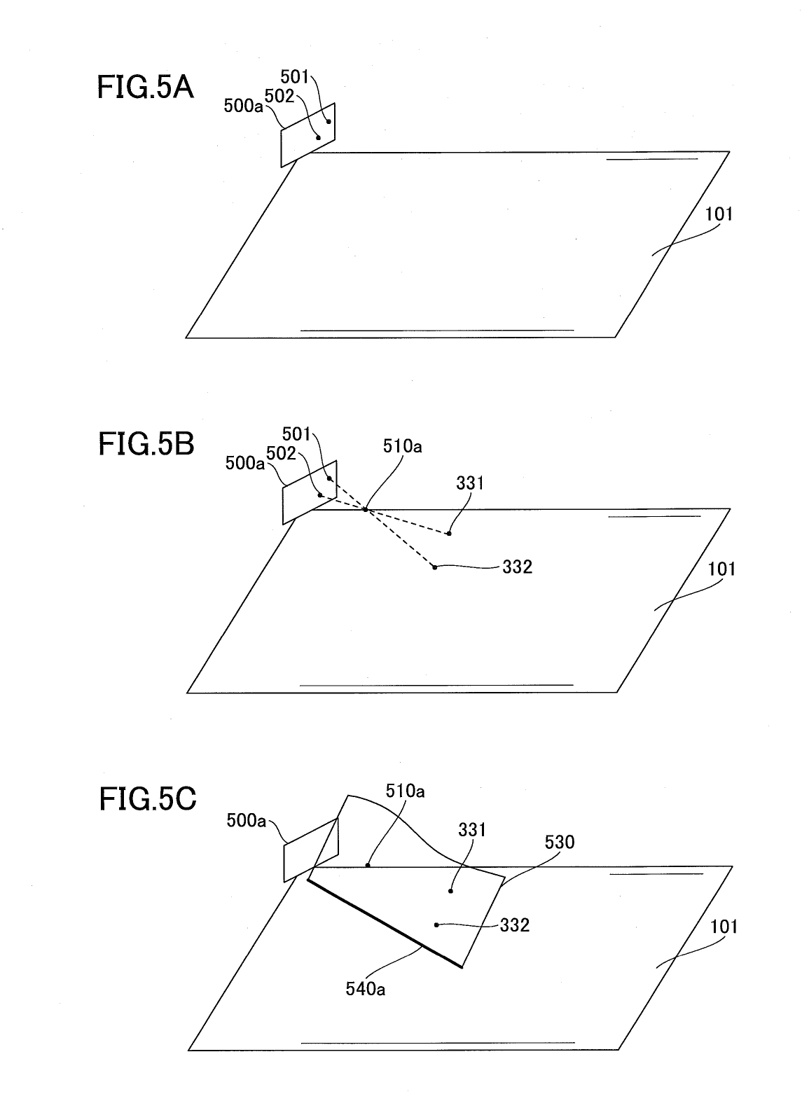

FIG. 5A illustrates an arrangement of a CMOS image sensor 500a of an image pick-up unit 103a producing a picked-up image in the coordinate detection system 100.

Referring to FIG. 5A, a point 501 indicates the element of the CMOS image sensor 500a corresponding to the two-dimensional coordinate of the center point 332 on the picked-up image. In a manner similar thereto, a point 502 indicates the element of the CMOS image sensor 500a corresponding to the two-dimensional coordinate of the center point 331 on the picked-up image. In step 3, the coordinates of the points 501 and 502 in the three-dimensional coordinate space are calculated.

Subsequently, a plane including the center points 331 and 332 of the light emission portions 321 and 322 and a principal point of the image pick-up unit 103a in the three-dimensional coordinate space is calculated (step 4). Because the center points 331 and 332 of the light emission portions 321 and 322 specify the canter axis of the pointer 110, the plane calculated in step 4 includes the center axis of the pointer 100 and the principal point of the image pick-up unit 103a (hereinafter, the plane is referred to as a “center axis plane”). The principal point is a cross point between an optical axis and a principal surface of a single thin lens replacing an optical system of the image pick-up unit 103a. In a case where the optical system of the image pick-up unit 103a is formed of a single lens, the center of the single lens may be the principal point).

FIG. 5B illustrates a mathematical model for explaining a projection (a relationship among the center points 331 and 332 of the light emission portions 321 and 322 and the element on the CMOS image sensor 500a) of the image pick-up unit 103a in the three-dimensional coordinate space. The mathematical model ordinarily called a “world coordinate model” or an “external model”, which are ordinarily known in a technical field using a camera.

As illustrated in FIG. 5B, the calculation of the center axis plane by step 4 is equivalent to a calculation of the plane including the elements (the points 501 and 502) on the CMOS image sensor 500a corresponding to the center points 331 and 332 and the principal point (the point 510a) of the image pick-up unit 103a. Therefore, in step 4, the plane including the elements (the points 501 and 502) on the CMOS image sensor 500a and the principal point (the point 510a) of the image pick-up unit 103a in the three-dimensional coordinate space is calculated as a center axis plane.

Subsequently, the intersecting line between the center axis plane calculated in step 4 and the input face of the coordinate input apparatus 101 is calculated (step 5).

FIG. 5C illustrates a relationship between the center axis plane and the input face of the coordinate input apparatus 101. Referring to FIG. 5C, a plane 530 is a center axis plane including the elements (the points 501 and 502) on the CMOS image sensor 500a corresponding to the center points 331 and 332 and the principal point (the point 510a) of the image pick-up unit 103a. Further, the intersecting line 540a is an intersecting line between the plane 530 being the center axis plane and the input face of the coordinate input apparatus 101. The intersecting line 540a is calculated in step 4.

Referring to FIGS. 5A to 5C, although only the image pick-up unit 103a is explained, an intersecting line 540b can be calculated by performing processes similar to steps 1-4 for the image pick-up unit 103b.

Subsequently, angles (turn angles) formed between the intersecting lines 540a and 540b calculated in step 5 and a reference direction on the input face of the coordinate input apparatus 101 are calculated, and the two-dimensional coordinate of the vertex 323 of the pointer 110 on the input face is calculated using the calculated turn angle (step 6).

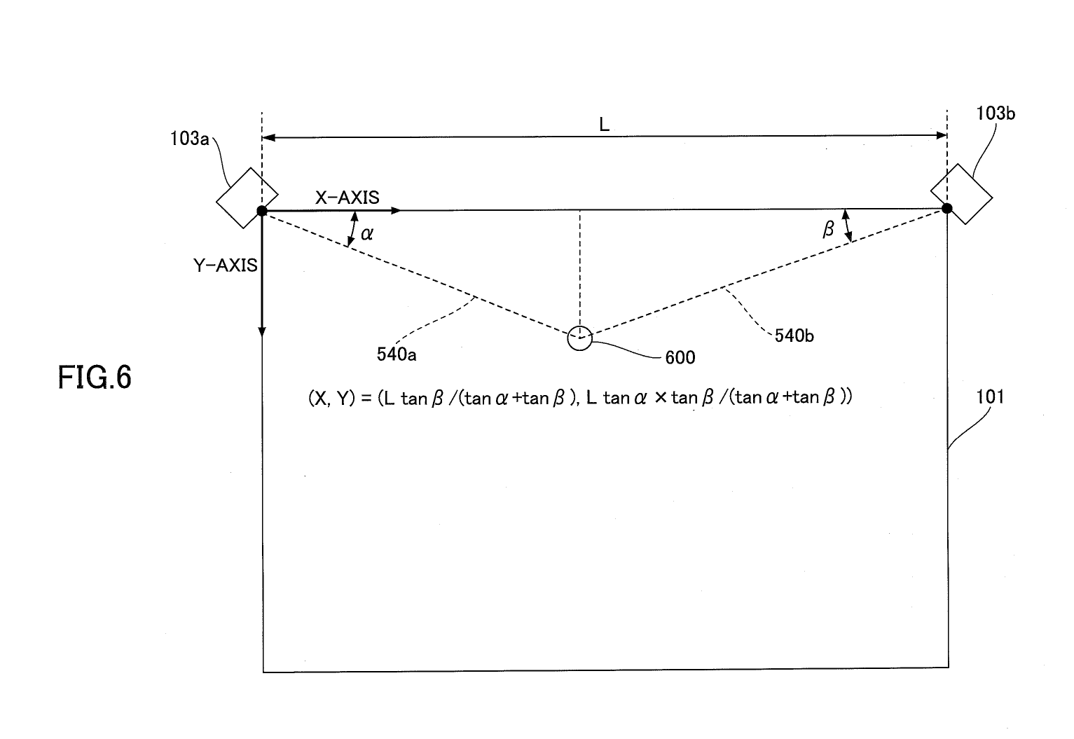

FIG. 6 explains a calculation method of calculating the two-dimensional coordinate of the vertex 323 of the pointer 110 on the input face based on the intersecting lines 540a and 540b.

Referring to FIG. 6, an intersection point (a point 600) between the intersecting lines 540a and 540b indicates a coordinate of the vertex 323 of the pointer 110 on the input face of the coordinate input apparatus 101.

Here, the upper left end of the coordinate input apparatus 100 is determined as an original point, the X-axis is determined in a lateral direction, and the Y-axis is determined in a lengthwise direction. Further, a turn angle of the point 600 from the X-axis (the reference direction) viewed at the image pick-up unit 103a is designated by α, and a turn angle of the point 600 from the X-axis (the reference direction) viewed at the image pick-up unit 103b is designated by β. Further, the width of the coordinate input apparatus 101 along the X-axis is designated by L.

On these premises, the Y coordinate of the point 600 is expressed using the X coordinate as follows:

Y=X tan α [Formula 1]

Y=(L−X)tan β [Formula 2]

Then, Y is eliminated from Formula 1 and Formula 2, and rearranged for X.

X=L tan β/(tan α+tan β) [Formula 3]

Further, Formula 3 is assigned to Formula 1 as follows:

X=L tan α×tan β/(tan α+tan β) [Formula 4]

Said differently, the X coordinate and the Y coordinate can be calculated by calculating the turn angles α and β of the intersecting lines 540a and 540b from the X-axis (the reference direction) based on the picked-up images shot by the image pick-up units 103a and 103b and assigning to Formulas 3 and 4. The above described process is based on the picked-up images shot by the image pick-up units 103a and 103b. A process similar to the above described process is applicable to picked-up images shot by the image pick-up units 103c and 103d. Therefore, an explanation of the process based on the picked-up images shot by the image pick-up units 103c and 103d is omitted.

As described above, in a case of the pointer 110 provided with the annular light emission portions 321 and 322, if the two-dimensional coordinates of the center points 331 and 332 of the light emission portions 321 and 322 on the picked-up images are calculated, the two-dimensional coordinates of the vertex 323 on the input face of the coordinate input apparatus 101 can be calculated.

Said differently, in a case where an error is included in the two-dimensional coordinates on the picked-up images corresponding to the center points 331 and 332 of the light emission portions 321 and 322, the coordinate of the vertex 323 on the input face of the coordinate input apparatus includes an error.

Here, the procedure explained using FIG. 4 is premised on no lens distortion in the image pick-up unit 103a. However, there is practically a lens distortion in the image pick-up unit 103a. Therefore, when the elements corresponding to the center points 331 and 332 of the light emission portions 321 and 322 and existing on the CMOS image sensor 500a are specified, the coordinates of the specified elements include an influence of the lens distortion.

Said differently, in a case of the image pick-up unit 103a including the lens distortion, a relationship between the center points 331 and 332 of the light emission portions 321 and 322 and the elements (the points 501 and 502) on the CMOS image sensor 500a is different from the relationship illustrated in FIG. 5B.

The inventor of the present invention has focused on this difference and has conceived a structure of eliminating the influence of the lens distortion. Hereinafter, the influence of the lens distortion in the image pick-up unit 103a and also the structure of eliminating the influence of the lens distortion are explained.

### <5. Explanation of Influence of Lens Distortion>

### <5.1 Internal Structure of Image Pick-Up Unit>

Before explaining the influence of the lens distortion, an internal structure of the image pick-up unit 103a is explained.

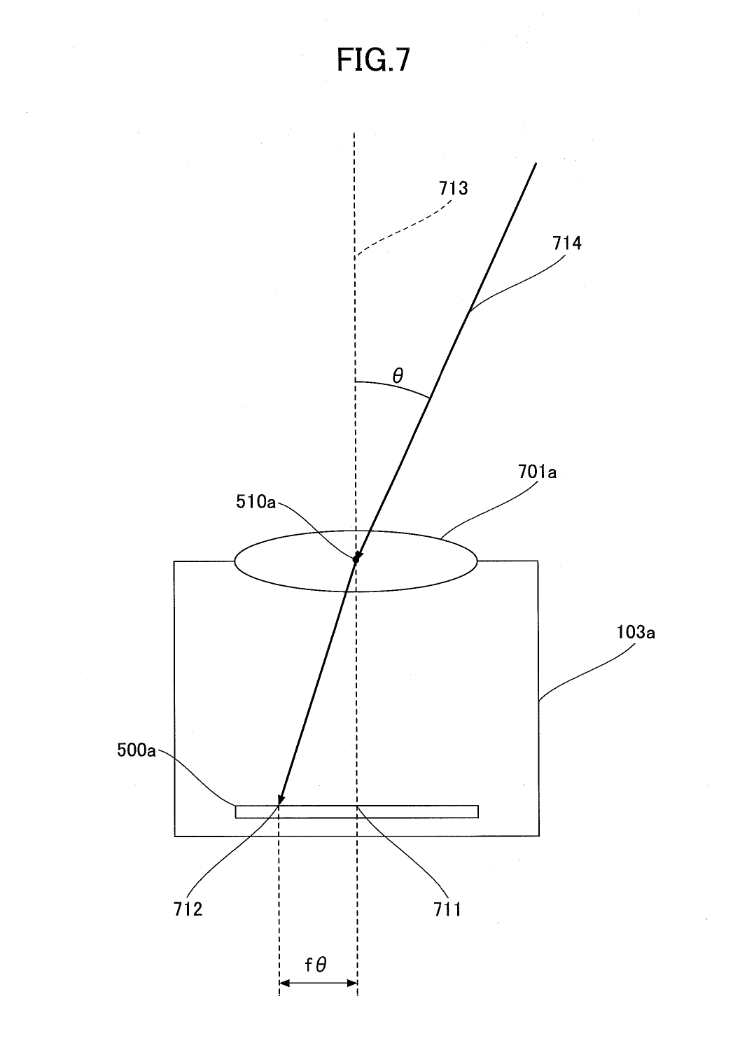

FIG. 7 illustrates the internal structure of the image pick-up unit 103a. Referring to FIG. 7, the image pick-up unit 103a includes the CMOS image sensor 500a and a lens 701a. The lens 701a has a lens distortional property called a fθ property.

A light ray 714 having an incident angle θ enters the image pick-up unit 103a, passes through a principal point (a point 510a) and is received by an element 712 on the CMOS image sensor 500a. At this time, a distance between a center element 711 and the element 712 on the CMOS image sensor 500a becomes fθ where the focal length of the lens 701a is f.

The incident angle θ is measured from an optical axis 713, which passes through the principal point (the point 510a) being the center of the lens 701a) and the center element 711 of the CMOS image sensor 500a and is perpendicular to the CMOS image sensor 500a.

### <5.2 Difference of Coordinate of Center Point Whether Lens Distortion Exists or Does Not Exists>

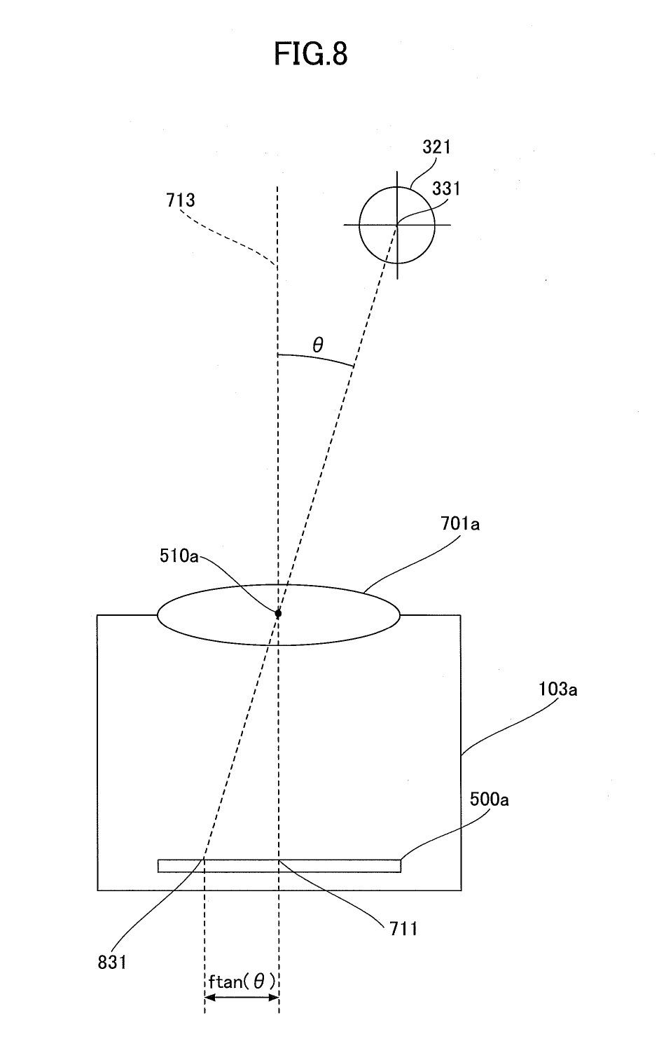

Next described is a difference of the coordinate of the element corresponding to the center point on the CMOS image sensor caused depending on whether the lens distortion exists or does not exist. FIG. 8 illustrates the coordinate of the element corresponding to the center point 331 on the CMOS image sensor 500a in a case where there is no lens distortion.

Referring to FIG. 8, the position of an element 831 on the CMOS image sensor 500a is obtained by projecting the center point 331 of the light emission portion 321 onto the CMOS image sensor 500a. In the case of a lens 701a having no lens distortion, a distance between the element 831 and the center element 711 is f tan(θ) where an angle between a straight line connecting the center point 331 of the light emission portion 321 and the principal point (the point 510a) and the optical axis is θ.

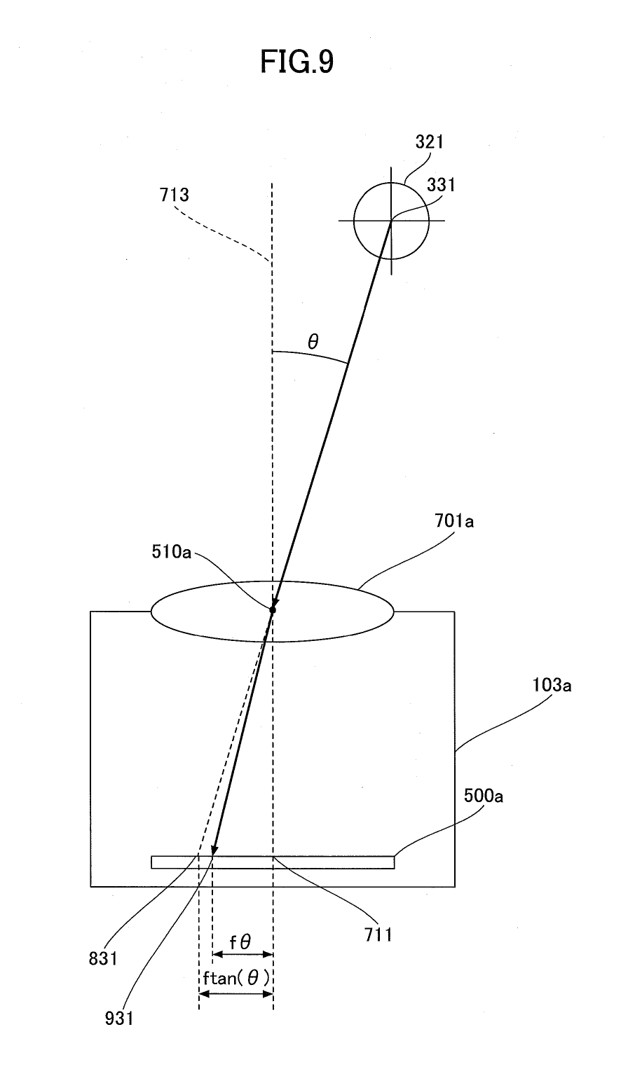

FIG. 9 illustrates the coordinate of the element corresponding to the center point 331 on the CMOS image sensor 500a in a case where there is the lens distortion.

Referring to FIG. 9, the position of an element 931 on the CMOS image sensor 500a is obtained by projecting the center point 331 of the light emission portion 321 onto the CMOS image sensor 500a. In the case of the lens 701a having the lens distortion, a distance between the element 931 and the center element 711 is fθ where an angle between a straight line connecting the center point 331 of the light emission portion 321 and the principal point (the point 510a) and the optical axis 713 is θ.

As described, depending on whether there is the lens distortion or not, the coordinates of the elements corresponding to the center point 331 on the CMOS image sensor 500a shift by f tan(θ)−fθ.

### <6. Calculation Method of Center Point Eliminating Influence of Lens Distortion>

Described next is a calculation method of calculating the coordinate of the element 931 on the CMOS image sensor 500a while eliminating the influence of the lens distortion.

Because the center point is inside the pointer 110, it is not possible to directly detect on the CMOS image sensor 500a. Therefore, an edge point of the light emission portion 321 is detected and the coordinate of the element corresponding to the center point 331 is calculated using the coordinate of the element corresponding to the edge point on the CMOS image sensor 500a.

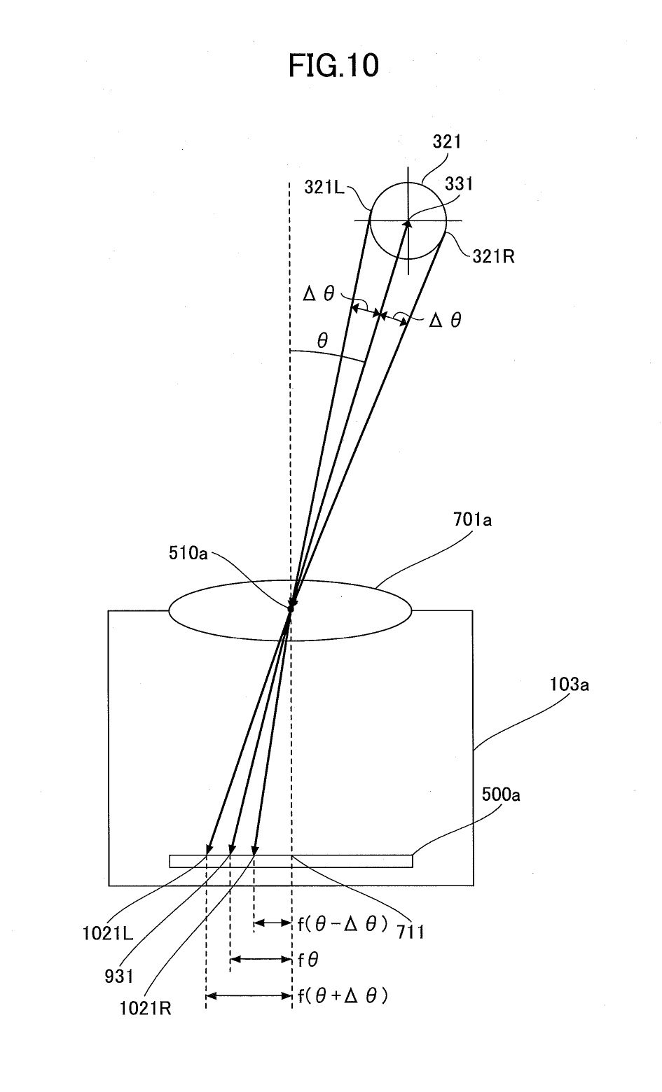

FIG. 10 illustrates a calculation method of the coordinate of the element 931 on the CMOS image sensor 500a. Referring to FIG. 10, a light emitted by an edge point 321L of the light emission portion 321 is received by an element 1021R on the CMOS image sensor 500a. A light emitted by an edge point 321R of the light emission portion 321 is received by an element 1021L on the CMOS image sensor 500a.

Here, a distance between the element 1021R and the center element 711 is f(θ−Δθ). Further, a distance between the element 1021L and the center element 711 is f(θ+Δθ).

Here, Δθ is an angle formed between a straight line connecting the edge point 321R or 321L of the light emission portion 321 to the principal point (the point 510a) and a straight line connecting the center point 331 of the light emission portion 321 and the principal point (the point 510a).

As known from FIG. 10, the element 931 is a midpoint between the element 1021L and the element 1021R. Therefore, the coordinate of the element 931 can be calculated based on the coordinate of the element 1021L and the coordinate of the element 1021R. Said differently, the two-dimensional coordinate of the element 931 on the picked-up image can be calculated by calculating the coordinate of the center position of a light emission area indicative of the light emission portion 321.

Therefore, within this embodiment, the coordinate of the center position of the light emission area indicative of the light emission portion 321 drawn on the picked-up image is firstly calculated so as to convert the coordinate of the calculated coordinate of the center position to a coordinate in a case where no distortion is assumed. Specifically, a correction is performed by multiplying the calculated coordinate of the center position with a lens distortion correction function to specify the element corresponding to the corrected coordinate of the center position on the CMOS image sensor 500a.

With the above structure, it is possible to specify the elements corresponding to the center points 331 and 332 of the light emission portion 321 and 322 on the CMOS image sensor 500a while eliminating the influence of the lens distortion.

### <Functional Structure of Coordinate Detection Program>

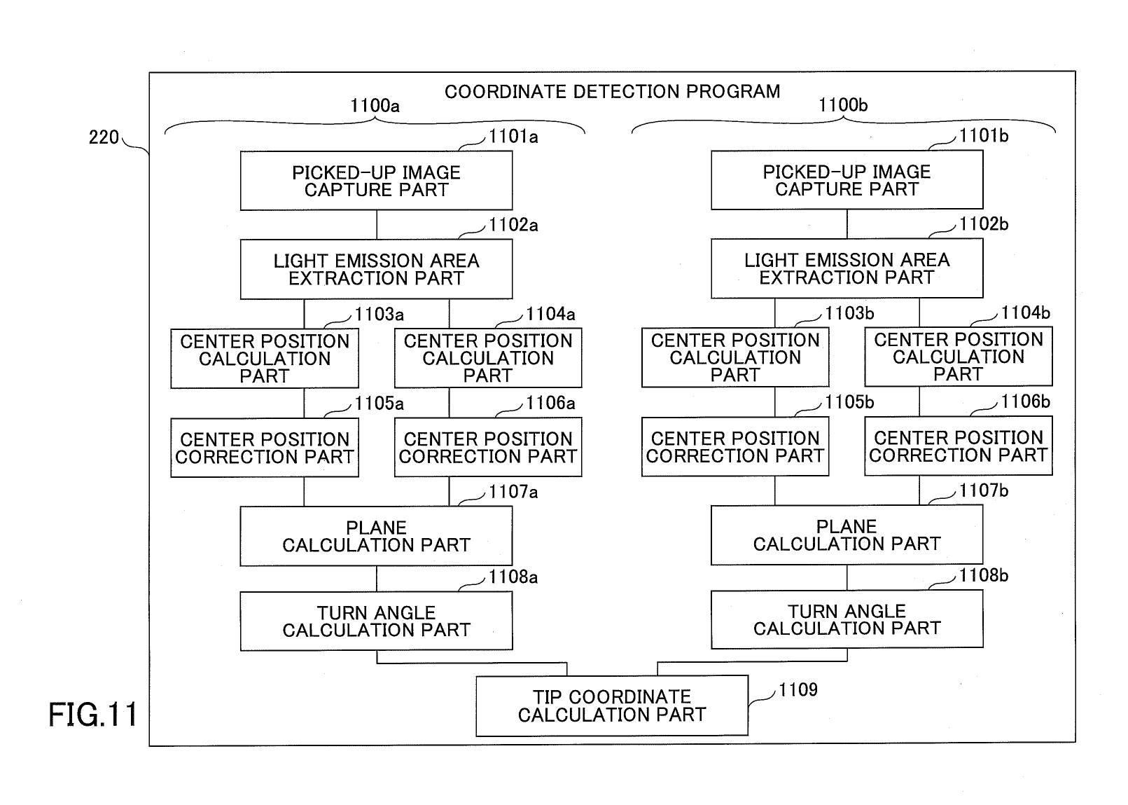

Described next is a functional structure of the coordinate detection system 220. A coordinate detection program 220 has a functional structure illustrated in FIG. 11 and performs as follows:

Calculating the two-dimensional coordinate corresponding to the center point of the light emission portion on the picked-up image using the relationship illustrated in FIG. 10;

Correcting the two-dimensional coordinate corresponding to the center point of the light emission portion on the picked-up image in consideration if the error caused by the lens distortion illustrated in FIG. 9; and

Calculating the two-dimensional coordinate of the vertex 323 of the pointer 110 on the input face in conformity with the procedure illustrated in FIG. 4.

FIG. 11 illustrates an exemplary functional structure of the coordinate detection program 220. The coordinate detection program 220 includes a process part 1100a processing a picked-up image shot by the image pick-up unit 102a and a process part 1100b processing a picked-up image shot by the image pick-up unit 103a. Further, the coordinate detection program 220 includes a tip coordinate calculation part 1109 which calculates the two-dimensional coordinate of the vertex 323 on the input face using a processing result obtained by the process part 1100a and a processing result obtained by the process part 1100b. Because the process performed by the process part 1100a is the same as the process performed by the process part 1100b, only the process part 1100a and the tip coordinate calculation part 1109 are described next.

The process part 1100a includes a picked-up image capture part 1101a, a light emission area extraction part 1102a, center position calculation parts 1103a and 1104a, center position correction parts 1105a and 1106a, a plane calculation part 1107a, and a turn angle calculation part 1108a.

The picked-up image capture part 1101a acquires the picked-up images shot by the image pick-up unit 103a at a predetermined period of time. The light emission area extraction part 1102a extracts light emission areas indicative of the light emission portions 321 and 322 drawn on the acquired picked-up image.

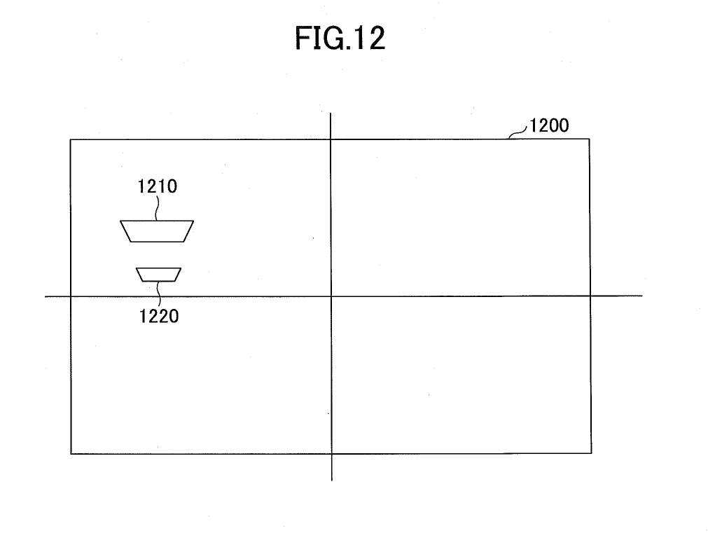

FIG. 12 illustrates light emission areas 1210 and 1220 drawn on a picked-up image 1200. Referring to FIG. 12, the light emission area 1210 corresponds to the light emission portion 321 of the pointer 110 and the light emission area 1220 corresponds to the light emission portion 322 of the pointer 110.

The center position calculation part 1103a calculates the two-dimensional coordinate corresponding to the center point 331 of the light emission portion 321 on the picked-up image 1200 based on the extracted light emission area. The center position calculation part 1104a calculates the two-dimensional coordinate corresponding to the center point 332 on the picked-up image 1200 based on the extracted light emission area.

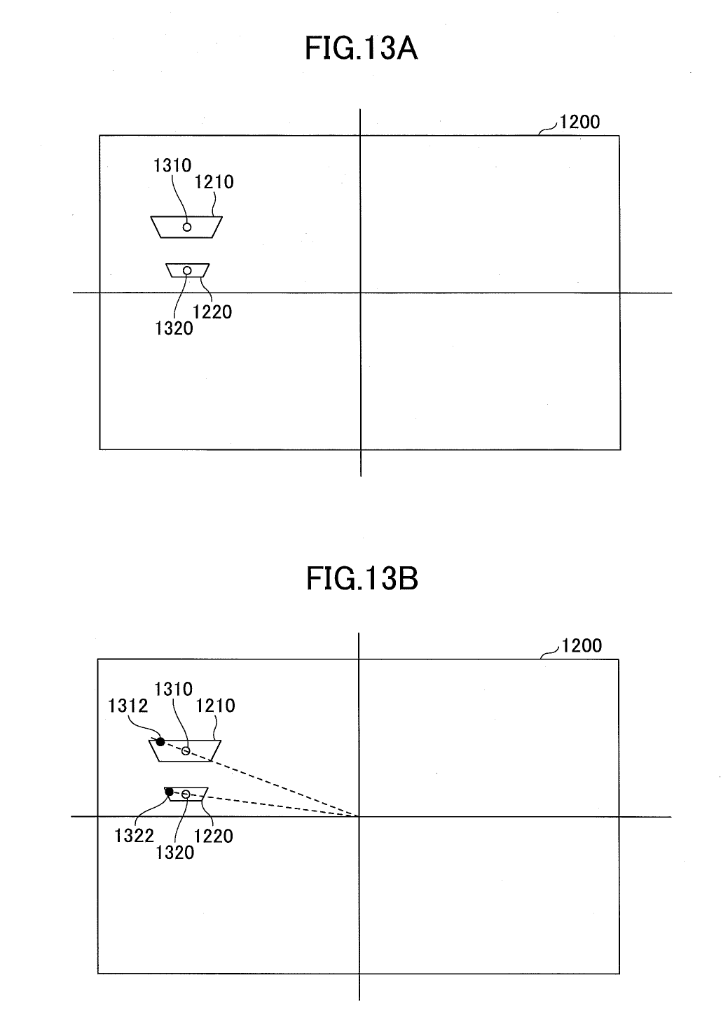

FIG. 13A illustrates calculations of the coordinates of pixels 1310 and 1320 corresponding to the center points 331 and 332 on the picked-up image 1200 performed by the center position calculation parts 1103a and 1104a. Referring to FIG. 13A, the coordinates of the pixels 1310 and 1320 can be calculated by respectively calculating barycentric positions of the light emission areas 1210 and 1220.

The center position correction part 1105a corrects coordinates of the pixels 1310 and 1320 corresponding to the center point 331 on the picked-up image 1200 using the lens distortion correction function so as to calculate the coordinate corresponding to the center point 331 in a case where no lens distortion is assumed. The center position correction part 1106a corrects coordinates of the pixels 1310 and 1320 corresponding to the center point 332 on the picked-up image 1200 using the lens distortion correction function so as to calculate the coordinate corresponding to the center point 332 in a case where no lens distortion is assumed.

FIG. 13B illustrates corrections of the coordinates of the pixels 1310 and 1320 using the center position correction parts 1105a and 1106a. Referring to FIG. 13B, the coordinates of the pixels 1312 and 1322 are calculated by respectively correcting the pixels 1310 and 1320.

The plane calculation part 1107a specifies the coordinates of elements (points 501 and 502) on the CMOS image sensor 500a based on the coordinates of the pixels 1312 and 1322 corresponding to the center points corrected using the lens distortion correction function. The plane calculation part 1107a calculates the center axis plane (the plane 530) including the coordinate of the elements (the points 501 and 502) of the CMOS image sensor 500a on the three-dimensional coordinate space and the coordinate of the principal point (the point 510a) of the image pick-up unit 103a on the three-dimensional coordinate space.

The turn angle calculation part 1108a calculates the intersecting line 540a between the calculated center axis plane and the input face of the coordinate input apparatus 101, and further calculates the turn angle α of the vertex 323 of the pointer 110 from the reference direction.

The tip coordinate calculation part 1109 calculates the coordinate of the point 600 indicative of the position of the vertex 323 on the input face based on the turn angle α calculated by the turn angle calculation part 1108a and the turn angle β calculated by the turn angle calculation part 1108b.

### <8. General Overview>

As described above, the coordinate detection system is structured as follows:

The two annular light emission portions are provided to the tip portion of the pointer and arranged in the longitudinal direction of the tip portion;

The coordinates of the center points of the two light emission portions on the corresponding picked-up images are calculated, and the two-dimensional coordinate of the vertex of the pointer on the input face of the coordinate input apparatus is calculated using the calculated two center points on the picked-up image; and

The two-dimensional coordinates of the center points of the two light emission portions on the picked-up image are corrected using the lens distortion correction function in calculating the two-dimensional coordinate of the vertex of the pointer on the input face of the coordinate input apparatus.

With this, an error of the two-dimensional coordinate of the vertex of the pointer caused by a lens distortion can be eliminated.

As a result, it is possible to accurately calculate the coordinate of the tip portion of the pointer in the coordinate detection system.

### Second Embodiment

Within the first embodiment, the intersecting lines between the center axis planes respectively calculated by the plane calculation parts 1107a and 1107b and the input face are calculated in calculating the two-dimensional coordinate of the vertex 323 of the pointer 110 on the input face.

However, the present invention is not limited to this, and an intersecting line between the center axis plane calculated by the plane calculation part 1107a and the center axis plane calculated by the plane calculation part 1107b may be calculated. The second embodiment is described below.

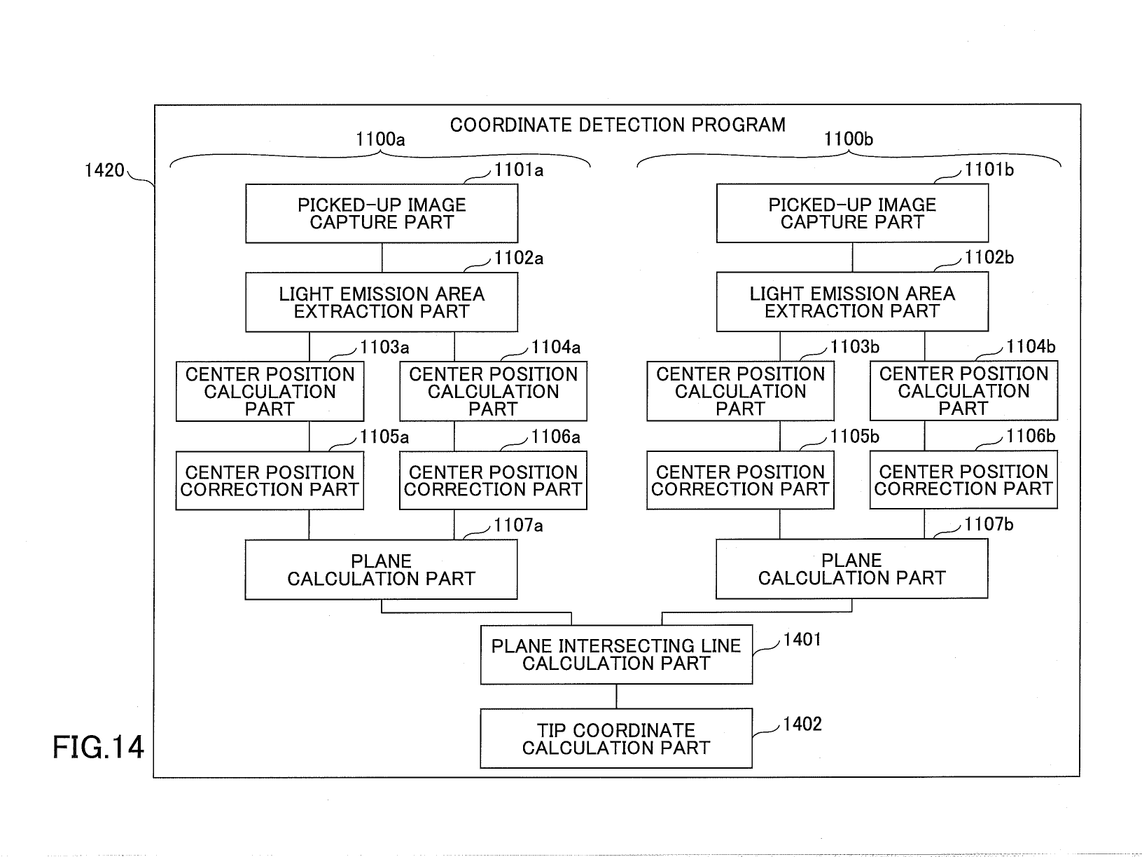

FIG. 14 illustrates a functional structure of a coordinate detection program 1420 of the second embodiment. In the functional structure illustrated in FIG. 14, the same parts as those in the coordinate detection program 220 illustrated in FIG. 11 are attached with the same reference symbols and description of these parts is omitted.

Differences of the functional structure of the coordinate detection program 220 illustrated in FIG. 11 exist in the plane intersecting line calculation part 1401 and the tip coordinate calculation part 1402.

The plane intersecting line calculation part 1401 calculates the intersecting line between the center axis plane calculated by the plane calculation part 1107a and the center axis plane calculated by the plane calculation part 1107b. The center axis planes respectively calculated by the plane calculation parts 1107a and 1107b are planes including both the center points 331 and 332 of the light emission portions 321 and 322. Therefore, the intersecting line between the center axis planes equals to the center axis of the pointer 110.

The tip coordinate calculation part 1402 calculates the intersection point between the intersecting line calculated by the plane intersecting line calculation part 1401 and the input face of the coordinate input apparatus 101, and calculates the two-dimensional coordinate of the vertex 323 of the pointer 110 on the input face of the coordinate input apparatus 101.

As such, even in a case where the intersecting line between the center axis plane calculated by the plane calculation part 1107a and the center axis plane calculated by the plane calculation part 1107b is calculated, the two-dimensional coordinate of the vertex 323 of the pointer 110 on the input face can be accurately calculated.

### Third Embodiment

Within the above embodiments, although the center position calculation parts 1103a and 1104a calculate the barycentric positions of the light emission areas 1210 and 1220 in order to calculate the coordinates corresponding to the center points 331 and 332 on the picked-up image, the present invention is not limited to this.

For example, the coordinates corresponding to the center points 331 and 332 on the picked-up image may be calculated based on the shapes of boundaries of the light emission areas 1210 and 1220.

Further, within the above embodiments, although the picked-up image capture parts 1101a and 1101b are structured to acquire all pixels included in the picked-up image, the present invention is not limited to this. For example, only pixels included in an area to a predetermined height from the input face of the coordinate input apparatus 101 may be acquired. Said differently, an area of interest (AOI) or a region of interest (ROI) is set, and only pixels included in the AOI or the ROI may be acquired.

### Fourth Embodiment

In the above embodiments, although conditions for starting an execution of the coordinate detection program 220 or 1420 are not referred to, the coordinate detection program 220 or 1420 may be started being executed based on a predetermined instruction, for example.

This predetermined instruction by the user may include a detection of a predetermined action by the user. For example, a sensor which can detect a touch of the vertex 323 onto the input face of the coordinate input apparatus 101 may be provided in the pointer 110, and the coordinate detection program 220 or 1420 may be executed in a case where the touch is detected by the sensor.

Within the above embodiments, although the two-dimensional coordinate of the vertex 323 of the pointer 110 on the input face is calculated regardless of a slant of the pointer 110 relative to the input face, the present invention is not limited to this. For example, it may be structured such that the two-dimensional coordinate of the vertex 32 of the pointer 110 on the input face is not calculated in a case where it is determined that the instruction input onto the input face by the pointer when the slant of the pointer 110 relative to the input face exceeds a predetermined threshold value.

### Fifth Embodiment

Within the embodiments, although the annular light emission portion is provided in the tip portion of the pointer, the present invention is not limited to this. What identified in the picked-up image may be provided instead of the light emission portion. For example, a paint (e.g., a fluorescent paint) having a predetermined color may be coated on an annular member, or the annular member may be made of a predetermined material (a reflective material).

Within the above embodiments, although the light emission portion of the pointer emits a light having a predetermined light quantity, the present invention is not limited to this. For example, a modulation circuit may be provided inside the pointer 110 so as to emit a modulated light.

### Sixth Embodiment

Within the above embodiments, the coordinate detection system 100 including the coordinate input apparatus 101, the computer (the information processing apparatus) 102, the image pick-up units 103a to 103d, and the peripheral light emission units 104a to 104d are formed to be a single apparatus.

However, the present invention is not limited to this. For example, any one or some of the coordinate input apparatus 101, the computer (the information processing apparatus) 102, the image pick-up units 103a to 103d, and the peripheral light emission units 104a to 104d may be separate.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although a coordinate detection system has been described in detail, it should be understood that various changes, substitutions, and alterations could be made thereto without departing from the spirit and scope of the invention.

This application is based upon and claims the benefit of priority of the prior Japanese Patent Application No. 2014-033680, filed on Feb. 25, 2014, the entire contents of which are incorporated herein by reference.

What is claimed is:

1. A coordinate detection system for detecting a coordinate pointed by a pointer with which a pointing operation is performed on a board face, the coordinate detection system comprising:
a first calculation unit that extracts a plurality of areas respectively indicative of a plurality of annular members provided in the pointer from a picked-up image picked by an image pick-up unit arranged at a predetermined position of the board face and calculates center positions of the extracted areas; and
a second calculation unit that calculates a position of a tip portion of the pointer on the board face based on the center positions of the areas calculated by the first calculation unit and a position of a principal point of the image pick-up unit.

2. The coordinate detection system according to claim 1, further comprising:
a correction unit that corrects the center positions of the areas calculated by the first calculation unit based on a lens distortional property of the image pick-up unit.

3. The coordinate detection system according to claim 1,
wherein the first calculation unit calculates a barycentric positions in the areas as the center positions.

4. The coordinate detection system according to claim 2,
wherein the second calculation unit calculates a plane including a coordinate of a pixel on a sensor of the image pick-up unit specified in a three-dimensional coordinate space based on the center positions of the areas corrected by the correction unit and a coordinate of the principal point of the image pick-up unit in the three-dimensional coordinate space, and calculates a position of the tip portion of the pointer based on the calculated plane.

5. The coordinate detection system according to claim 1,
wherein the annular members of the pointer are arranged in perpendicular to a predetermined axis,
wherein the predetermined axis is arranged so as to conform with the center points of the annular members.

6. An information processing apparatus for controlling a coordinate input apparatus having a board face, on which a pointing operation is performed by a pointer, the information processing apparatus comprising:
a first calculation unit that extracts a plurality of areas respectively indicative of a plurality of annular members provided in the pointer from a picked-up image picked by an image pick-up unit arranged at a predetermined position of the board face and calculates center positions of the extracted areas; and
a second calculation unit that calculates a position of a tip portion of the pointer on the board face based on the center positions of the areas calculated by the first calculation unit and a position of a principal point of the image pick-up unit.

7. The information processing apparatus according to claim 6, further comprising:
a correction unit that corrects the center positions of the areas calculated by the first calculation unit based on a lens distortional property of the image pick-up unit.

8. The information processing apparatus according to claim 6,
wherein the first calculation unit calculates a barycentric positions in the areas as the center positions.

9. The information processing apparatus according to claim 7,
wherein the second calculation unit calculates a plane including a coordinate of a pixel on a sensor of the image pick-up unit specified in a three-dimensional coordinate space based on the center positions of the areas corrected by the correction unit and a coordinate of the principal point of the image pick-up unit in the three-dimensional coordinate space, and calculates a position of the tip portion of the pointer based on the calculated plane.

10. A computer-readable recording medium with a program recorded thereon, the program being executed by a processor in an information processing apparatus for controlling a coordinate input apparatus having a board face, on which a pointing operation is performed by a pointer, wherein the program is executed by the processor to cause the information processing apparatus to implement:
a first calculation unit that extracts a plurality of areas respectively indicative of a plurality of annular members provided in the pointer from a picked-up image picked by an image pick-up unit arranged at a predetermined position of the board face and calculates center positions of the extracted areas; and
a second calculation unit that calculates a position of a tip portion of the pointer on the board face based on the center positions of the areas calculated by the first calculation unit and a position of a principal point of the image pick-up unit.
